(19) United States
(12) Patent Application Publication
(10) Pub. No.: US 2017/0308637 A1
(43) Pub. Date: Oct. 26, 2017

(54) PROBABILISTIC THERMAL HOTSPOT ACCOMMODATION

(71) Applicant: QUALCOMM INCORPORATED, San Diego, CA (US)

(72) Inventors: PALKESH JAIN, BANGALORE (IN); MANOJ MEHROTRA, KANPUR (IN)

(21) Appl. No.: 15/136,512

(22) Filed: Apr. 22, 2016

(51) Int. Cl. G06F 17/50

(52) U.S. Cl. CPC G06F 17/5081; G06F 17/5072; G06F 2217/80

(57) ABSTRACT

Implementations for probabilistic thermal hotspot accommodation are disclosed herein. In an example aspect, a cell library includes cells having respective leakage current characteristics that include a leakage current variability as well as a leakage current average. In another example aspect, a method obtains cell attribute collections for respective types of multiple cells, with each of the cell attribute collections including a leakage current average and a leakage current variability corresponding to a circuit device of a respective type of cell. The method also obtains an integrated circuit design that describes how multiple circuit devices are interconnected. The method then performs a thermal analysis of the integrated circuit design using the cell attribute collections for the respective types of multiple cells including at least the leakage current variability and the leakage current average.

### TECHNICAL FIELD

This disclosure relates generally to handling thermal constraints imposed on integrated circuits (ICs) due to current flows and, more specifically, to accommodating heat that is generated from leakage currents by the probabilistic identification and amelioration of thermal hotspots as well as by the reduction of the likelihood of thermal hotspot generation due to leakage currents.

### BACKGROUND

Integrated circuits enable numerous facets of modem life by providing the intelligence behind electronic devices. For example, computing devices such as internet servers and mobile phones are powered by integrated circuit processors. Integrated circuit processors are also embedded in many different types of products, from toys and televisions to cars and construction equipment. Thus, integrated circuits enable functionality ranging from playing video games to sending social media communications and from autonomously driving a vehicle to controlling a manufacturing robot. To enable these functionalities, electronic devices and machines execute complex programs utilizing both general-purpose and specially-designed types of integrated circuits.

Regardless of the type of integrated circuit or the intended functionality, most integrated circuits today operate using voltages and currents. Voltages and currents represent the binary mathematics and logic used to realize the complex programs executed by the integrated circuits. Transistors, which can operate as switches, and other circuit devices typically manipulate the voltages and currents as part of a computing program. Changing voltage levels or opening and closing switches cause currents to flow or stop flowing between or among a multitude of different circuit devices. In modern processors, voltage levels and switches can be changed millions, hundreds of millions, or even billions of times each second. All of these current flows generate heat within an integrated circuit chip, and heat causes a number of serious problems. For example, heat generation forces an integrated circuit to operate more slowly and reduces battery life of a portable electronic device. Furthermore, uncontrolled heat accumulation can destroy the integrated circuit chip or even damage surrounding components.

Different types of circuit devices are usually disposed at different locations around an integrated circuit chip. Different computing functionalities are also provided by various groups of circuit devices located at different portions of the integrated circuit chip. Consequently, heat is rarely generated uniformly across the chip. Instead, a particular portion of the integrated circuit at a particular location on the chip tends to generate more heat than other portions or locations. This particular circuit portion or chip location is called a thermal hotspot. Thus, a thermal hotspot is generated by current flowing through circuit devices of an integrated circuit chip.

Two types of current exist in a typical integrated circuit chip: drive current and leakage current. Drive currents are intentional currents that flow when transistors are turned on by a requisite voltage level. Leakage currents, on the other hand, are unintentional currents that occur despite a transistor being turned off. In comparison to one another, drive currents are typically orders of magnitude larger than leakage currents. Drive currents, however, can be more easily controlled because these currents cease to flow if transistors are turned off, such as when the transistors are not in use. Leakage currents, on the other hand, are more difficult to control because leakage currents that are associated with a given group of circuit devices continue to flow unless power to the group of circuit devices is removed.

Consequently, leakage currents can be a significant source of heat generation on an integrated circuit chip. Unfortunately, conventional approaches to account for thermal hotspots that result from leakage currents fail to adequately predict, ameliorate, or otherwise accommodate such thermal hotspots.

SUMMARY

In an example aspect, a method for probabilistic thermal hotspot accommodation is disclosed. The method obtains cell attribute collections for respective types of multiple cells, with each of the cell attribute collections including a leakage current average and a leakage current variability corresponding to a circuit device of a respective type of cell. The method also obtains an integrated circuit design that describes how multiple circuit devices are interconnected. The method then performs a thermal analysis of the integrated circuit design using the cell attribute collections for the respective types of multiple cells including at least the leakage current variability and the leakage current average.

In an example aspect, an integrated circuit is disclosed. The integrated circuit includes circuitry configured to execute instructions such that current flowing during execution of the instructions produces a thermal hotspot at one or more of multiple locations of the circuitry. The integrated circuit also includes multiple hotspot amelioration mechanisms respectively positioned at the multiple locations, the multiple hotspot amelioration mechanisms configured to dissipate heat generated by the thermal hotspot during execution of the instructions.

In an example aspect, a method for probabilistic thermal hotspot accommodation is disclosed. The method segregates an integrated circuit design into multiple regions. The method also computes a leakage current variability corresponding to each respective region of the multiple regions. The method further performs an analysis for sensitivity to local variations based on the leakage current variability corresponding to each respective region of the multiple regions. Based on the analysis, the method then adjusts a design of at least one region of the multiple regions to decrease the sensitivity to the local variations.

In an example aspect, computer program product having a computer readable medium tangibly recording computer program logic for for probabilistic thermal hotspot accommodation is disclosed. The computer program product includes code to segregate an integrated circuit design into multiple regions. The computer program product also includes code to compute a leakage current variability corresponding to each respective region of the multiple regions, with the leakage current variability indicative of a likely spread of a leakage current within each respective region. The computer program product further includes code to analyze the multiple regions based on the leakage current variability corresponding to each respective region of the multiple regions. The computer program product additionally includes coed to adjust a design of at least one region of the multiple regions based on the analyzing to manage likely development of at least one probabilistic thermal hotspot due to the leakage current.

### BRIEF DESCRIPTION OF DRAWINGS

FIG. 1 illustrates an example of an integrated circuit having multiple different blocks in which a thermal hotspot may develop.

FIG. 2 illustrates an example segregation of an integrated circuit into multiple regions that each include multiple cells.

FIG. 3 illustrates examples of a cell and a corresponding cell attribute collection of a cell library.

FIG. 4 illustrates examples of transistor devices having different numbers of fingers.

FIG. 5 illustrates an example approach to identifying multiple likely locations of probabilistic thermal hotspots.

FIG. 6 illustrates an example integrated circuit that includes multiple thermal hotspot amelioration mechanisms positioned based on multiple identified likely locations of probabilistic thermal hotspots.

FIG. 7 is a flow chart illustrating an example process for managing tolerance to leakage current variability on a region-by-region basis.

FIG. 8 illustrates a region that is less tolerant and a region that is more tolerant to local variations that cause leakage current variability.

FIG. 9 illustrates an integrated circuit having an outer core with a heightened tolerance to local variations and an integrated circuit having an inner core with a heightened tolerance to local variations.

FIG. 10 illustrates an example of an integrated circuit design adjustment module to manage tolerance for leakage current variability on a region-by-region basis.

FIG. 11 is a flow diagram illustrating an example process for probabilistic thermal hotspot accommodation.

FIG. 12 is another flow diagram illustrating another example process for probabilistic thermal hotspot accommodation.

FIG. 13 depicts an example of a processing system to implement a process or system in accordance with one or more example implementations.

### DETAILED DESCRIPTION

Integrated circuits (ICs) are becoming increasingly complex. A modern integrated circuit, such as a system on a chip (SoC), can have hundreds of millions of transistors. With a complex integrated circuit chip, these hundreds of millions of transistors can be organized into a dozen or more functional blocks. Examples of functional blocks include processing cores, memory arrays, wireless radios, and so forth. A functional block can have a unique structure relative to other blocks to enable the handling of different processing tasks or functionalities, or a functional block can be a duplicate of other blocks to facilitate the performance of parallel processing tasks or similar functionalities. Implementing various types of functional blocks further complicates modern integrated circuits. As chip complexity increases, the ability to predict the performance and operational characteristics of integrated circuits becomes correspondingly more complex and consequently more difficult.

For example, predicting the amount and thermal effects of leakage current becomes more difficult as integrated circuits become more complex. Conventional approaches to chip design attempt to analyze leakage current across the entirety of an integrated circuit as if the whole of the chip structure is homogenous. For purposes of analyzing leakage currents, the effects of variations in the physical structure of the integrated circuit are assumed to average out across the chip. A predicted thermal hotspot is ascertained by analyzing an entire integrated circuit chip using an average leakage current level. A conventional analysis therefore involves the use of a deterministic approach to ascertain a predicted location of a single thermal hotspot. This conventional approach can model global variations from a die-to-die perspective due to the existence of hundreds of millions of transistors and the law of large numbers. Unfortunately, this straightforward and deterministic approach fails to address the substantial intra-die leakage current variability that develops in modern integrated circuits as a result of building the hundreds of millions of transistors over many different regions of multiple different functional blocks across a chip.

Moreover, the impact of regional variations of leakage current increases as the number of functional blocks of an integrated circuit increase and as the feature sizes of individual circuit devices decrease. As chips continue to become more complex, the number of different functional blocks is expected to increase. Further, the integrated circuit industry is continually attempting to lower power consumption and increase processing speed by decreasing the feature size of circuit devices. So the inadequate results of conventional deterministic approaches to leakage current analysis are likely to become increasingly inaccurate.

In contrast, certain implementations that are described herein employ stochastic approaches to analyzing leakage current. A stochastic approach is implemented by considering leakage current variability in addition to average leakage current. Each individual circuit device corresponds to both an average level of leakage current and a leakage current variability. By way of example, the average leakage current can be implemented with a mean (μ), and the variability can be implemented with a standard deviation (σ) or a variance (σ²). The leakage current variability represents an expected spread of the leakage current about the average leakage current. Thus, the leakage current variability provides a probabilistic range of likely leakage currents around the average level of leakage current.

Statistical leakage variations can be incorporated in a bottom-up manner into power calculations or thermal hotspot calculations. A thermal analysis of an integrated circuit chip can therefore identify likely locations of multiple potential thermal hotspots, or multiple probabilistic thermal hotspots. Based on these likely locations, multiple thermal hotspot amelioration mechanisms may be incorporated into the chip. Additionally or alternatively, the design of an integrated circuit chip can be modified based on an analysis of leakage current variability of a region-by-region basis to proactively reduce a leakage current variability in one or more regions.

In addition to leakage currents that vary from die-to-die, leakage currents also vary from block-to-block, or between even smaller areas, of a given die to a degree that a chip's thermal performance is affected. These smaller areas are called regions herein. Leakage currents can vary from region-to-region within a single die due to two primary causes: random variations and systematic variations. Random variations arise primarily through random dopant fluctuations. Random variations are also called local variations or mismatches (MM) herein. These random variations are independent and uncorrelated. Systematic variations arise from other sources, such as lithographic-based variations. Systematic variations tend to exhibit a high amount of correlation—in other words, cells that are adjacent to each other tend to respond similarly. Random variations of leakage current are addressed herein by considering leakage current variability in the design and analysis of integrated circuit chips.

In one or more example implementations, an integrated circuit design describes how circuit devices are interconnected. A library of cells is provided with each cell corresponding to a circuit device and including one or more cell attributes. The cell attributes include such characteristics as size, device type, inputs, outputs, voltage and current parameters, and so forth. Examples of current parameters include a leakage current average level, a leakage current variability, and so forth. Examples of a leakage current variability include a standard deviation (σ), a variance (σ²), and so forth. A processing system conducts a thermal analysis on the integrated circuit design using the library of cells. The thermal analysis can be performed on a region-by-region basis. For example, multiple likely locations of at least one probabilistic thermal hotspot are identified by analyzing the circuit devices within each region in terms of average leakage current and leakage current variability. An integrated circuit chip can be produced that includes multiple thermal hotspot amelioration mechanisms deployed at respective ones of the multiple likely locations of the at least one thermal hotspot. Examples of hotspot amelioration mechanisms include thermal vias, thermoelectric cooling (TEC) units, and so forth.

In these manners, probabilistic thermal hotspots are accommodated by identifying corresponding likely locations and ameliorating the probable thermal effects. Independent or uncorrelated random variations in the physical structure of an integrated circuit chip occur during fabrication and cause local variations in the leakage currents. To account for these local variations, a leakage current variability is associated with each cell of a cell library. By analyzing an integrated circuit design on a region-by-region basis using leakage current variability values in conjunction with leakage current averages, the likely locations of multiple probabilistic thermal hotspots can be identified. Identification of the likely locations enables the incorporation of ameliorative mechanisms to manage the potential thermal hotspots of a given integrated circuit design.

In one or more example implementations, an integrated circuit design is segmented into different regions, such as an array of rectangular grids. Each region is independently analyzed to determine a region-level leakage current variability. The individual leakage current variabilities associated with respective ones of the circuit devices included in a given region are used to determine the region-level leakage current variability. If the region-level leakage current variability exceeds a threshold, the circuit design of the region is modified to lower the region-level leakage current variability. For example, the number of cells within the region can be increased. Additionally or alternatively, the number of fingers used to implement a circuit device can be increased. For instance, a transistor can be implemented with four fingers instead of a single finger to decrease the leakage current variability of a given cell. Different regions can thereby be made more tolerant to leakage current variability.

In these manners, probabilistic thermal hotspots are accommodated by reducing the likelihood of the thermal hotspots actually occurring or by shifting the likely locations of occurrence. For example, the likelihood of thermal hotspots actually occurring can be reduced by lowering the leakage current variability for one or more regions. Additionally or alternatively, an area within an interior of a chip, which is called an inner core herein, can be made relatively more tolerant to local variations as compared to an area along an exterior of the chip, which is called an outer core herein. Probabilistic thermal hotspots that are produced due to leakage current variability are therefore more likely to occur in the outer core where heat is less likely to accumulate or is more easily dissipated. Thus, the thermal sensitivity of an integrated circuit design to local variations can be reduced by managing the level of leakage current variability in different regions.

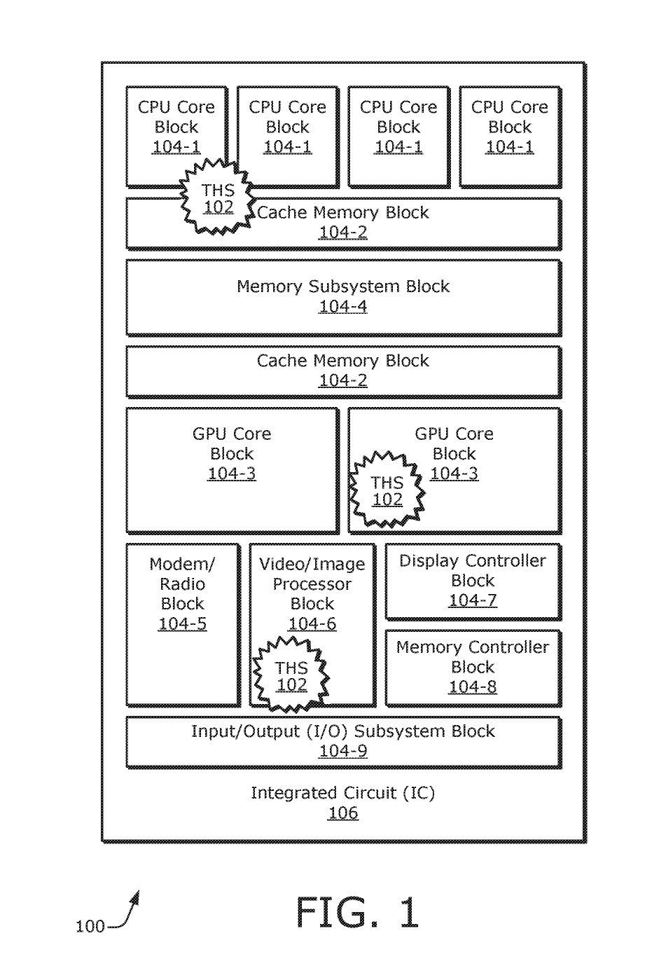

FIG. 1 illustrates generally at 100 an example of an integrated circuit 106 having multiple different blocks 104-1 to 104-9 in which a thermal hotspot 102 may develop. Modern integrated circuits typically include multiple blocks 104, such as multiple processing cores, a processing core and a memory, a graphics processor and a display controller, and so forth. A system on a chip (SoC), for instance, combines multiple different functional components into a single chip. An example of an SoC is shown at 100.

In FIG. 1, the integrated circuit 106 is illustrated as including fourteen blocks 104. Four central processing unit (CPU) core blocks 104-1 at the top of the chip share an upper cache memory block 104-2. Two graphics processing unit (GPU) blocks 104-3 in the middle of the chip share a lower cache memory block 104-2. A main memory is represented by a memory subsystem block 104-4. As shown in the bottom third of the chip, the integrated circuit 106 also includes a modem/radio block 104-5, a video/image processor block 104-6, a display controller block 104-7, and a memory controller block 104-8. Additionally, input/output (I/O) operations for the chip are enabled at least partially by an I/O subsystem block 104-9.

A thermal hotspot 102 can develop if heat generated by current flows accumulates at some location of the integrated circuit 106. Three example locations for a thermal hotspot 102 are shown in FIG. 1. A first location is at the video/image processor block, and a second location is at one of the GPU core blocks. A third location overlaps two of the CPU core blocks as well as the upper cache memory block. A thermal hotspot 102 can be deemed to occur at a hottest location of the integrated circuit 106, at a location that first reaches a threshold temperature under a given use case, at any location that reaches a threshold temperature, at a location that reaches a temperature that jeopardizes safe or reliable operation of the integrated circuit 106, some combination thereof, and so forth. A thermal hotspot 102 can also vary in size as well as location.

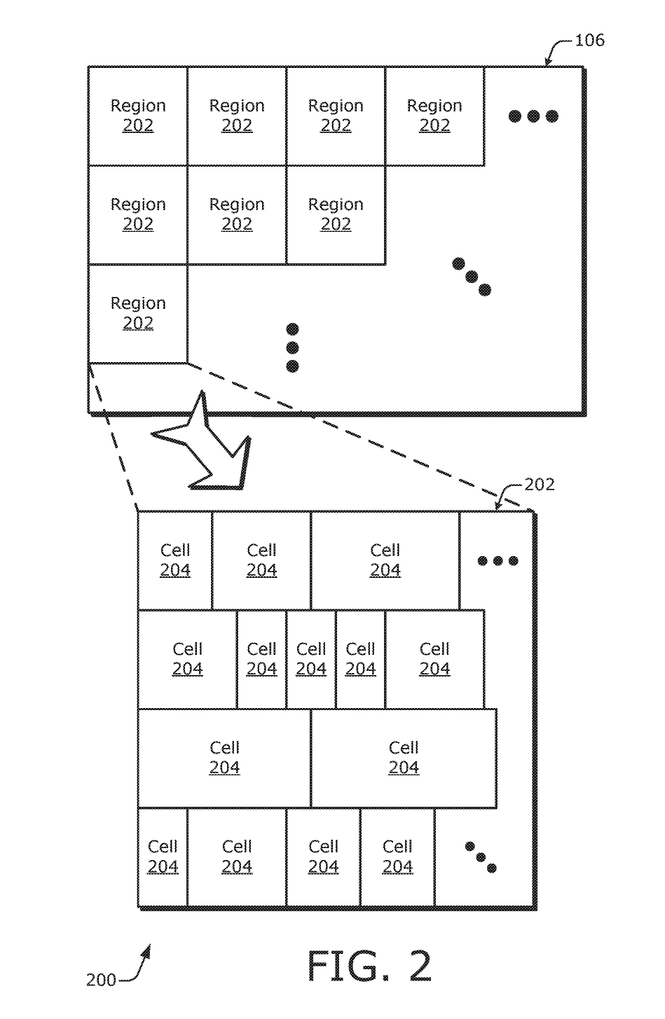

FIG. 2 illustrates generally at 200 an example segregation of an integrated circuit 106 into multiple regions 202 that each include multiple cells 204. In accordance with certain example implementations, a design of an integrated circuit 106 is segregated into multiple regions 202 to facilitate analysis. As described further below, the integrated circuit design can be analyzed for probabilistic thermal hotspots on a region-by-region basis. The integrated circuit 106 can be segregated into any number of regions 202. Each region 202 can be any shape or size, and different regions 202 can be different shapes or sizes. Example shapes for different regions 202 include hexagonal, rectangular, triangular, or combinations thereof. As shown, each region 202 is a rectangular grid of multiple rectangular grids, which together form a two-dimensional array of rectangular grids. An example size for a square grid is 10 nm×10 nm.

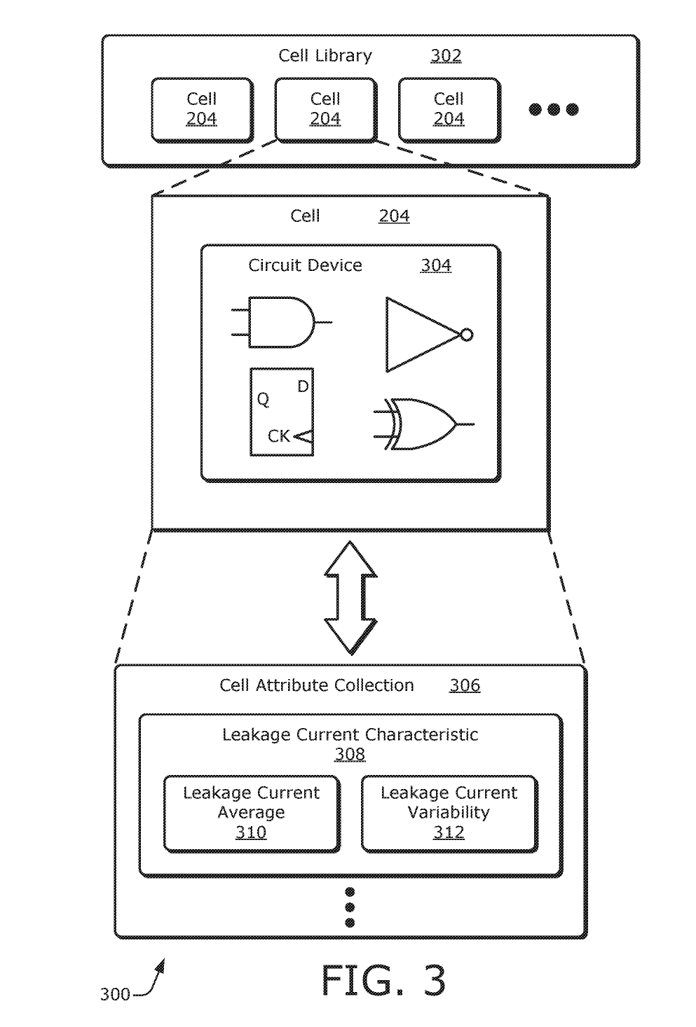

Each region 202 includes multiple cells 204 as shown by the enlarged region 202 in the lower half of the drawing. A cell 204 is a set of one or more circuit elements forming a circuit device that is reusable across an integrated circuit 106. Examples of cells are described below with reference to FIG. 3. Although a particular number of cells 204 and rows of cells 204 are shown in FIG. 2, a region 202 may include any number of cells 204 or rows thereof. Each cell 204 can be any shape or size, and different cells 204 can be different sizes or shapes. In some conventions, but by way of example only, each cell 204 is rectangular and has a common height but a width that varies from cell to cell. Although this convention is followed herein, the described principles are not so limited. As shown, the region 202 includes four rows of cells 204. From top to bottom, the rows include three, five, two, and four cells 204 per respective row.

FIG. 3 illustrates generally at 300 examples of a cell 204 and a corresponding cell attribute collection 306 of a cell library 302. The cell library 302 includes descriptions of multiple types of cells 204. Each cell 204 enables or represents the inclusion of at least one circuit device 304 into an integrated circuit design by selecting the description of the cell 204. As used herein, the word “cell” may refer to a physical implementation of a circuit device on an integrated circuit chip or a description of the circuit device as part of a cell library or integrated circuit design. Circuit devices 304 can range from relatively basic electrical engineering circuit elements to relatively complex computer science constructs, some examples of which are depicted in FIG. 3. Examples of circuit devices 304 include resistors, capacitors, transistors, logic gates such as AND or XOR, a buffer or inverter, a flip-flop, a unit or bank of memory, a register, a multiplexer, an accumulator, an arithmetic logic unit, or combinations thereof.

Each cell 204 of the cell library 302 includes a corresponding cell attribute collection 306 that describes the cell 204. Attributes of the cell attribute collection 306 can include a name or type of the circuit device 304, physical attributes such as length or width, input and output terminals, nominal voltages, timing specifications, number of fingers used to implement the circuit device 304, current characteristics, combinations thereof, and so forth. An example of current characteristics is a leakage current characteristic 308. The leakage current characteristic 308 is indicative of a current level that a transistor generates, passes, or otherwise produces if the transistor is turned off but is still coupled to a power source. As shown, the leakage current characteristic 308 includes a leakage current average 310 and a leakage current variability 312.

In example implementations, the leakage current average 310 is indicative of the average leakage current across different processes, temperatures, and so forth. An example for the leakage current average 310 is at least one value indicative of a mean (μ) of the leakage current. The leakage current variability 312 is indicative of how much or how far the leakage current is expected or is likely to deviate from the average. In other words, the leakage current variability 312 can stochastically indicate a spread of the leakage current average 310 for different circuit devices 304 across different situations. An example for the leakage current variability 312 is at least one value indicative of a standard deviation (σ) or a variance (σ²).

An indication of a leakage current variation spread is ascertainable based on the leakage current average 310 and the leakage current variability 312. More specifically, a leakage current variation spread indicator can be determined using a ratio of the leakage current variability 312 to the leakage current average 310. An example of a leakage current variation spread indicator is the coefficient of variation, which is calculated by dividing the standard deviation (σ) by the mean (μ). A value of the leakage current variability 312 or the leakage current variation spread indicator is indicative of a cell's or a region's sensitivity to local variations in the physical structure of an integrated circuit chip.

Thus, each individual circuit device can correspond to a leakage current mean (μ) and a leakage current standard deviation (σ). Due to the central limit theorem and the law of large numbers, the coefficient of variation (σ/μ) decreases as the number of circuit devices increases on a chip. Thus, the spread of the mean of the leakage current can be ignored at larger scales, such as at the die level for an SoC. At smaller scales, however, the spread of the leakage current mean, and thus the variability of the leakage current, does have an appreciable effect on current flows. The leakage current variability is therefore considered at smaller scales. To analyze leakage current at a smaller scale, a die is divided into smaller areas such as the regions 202 of FIG. 2.

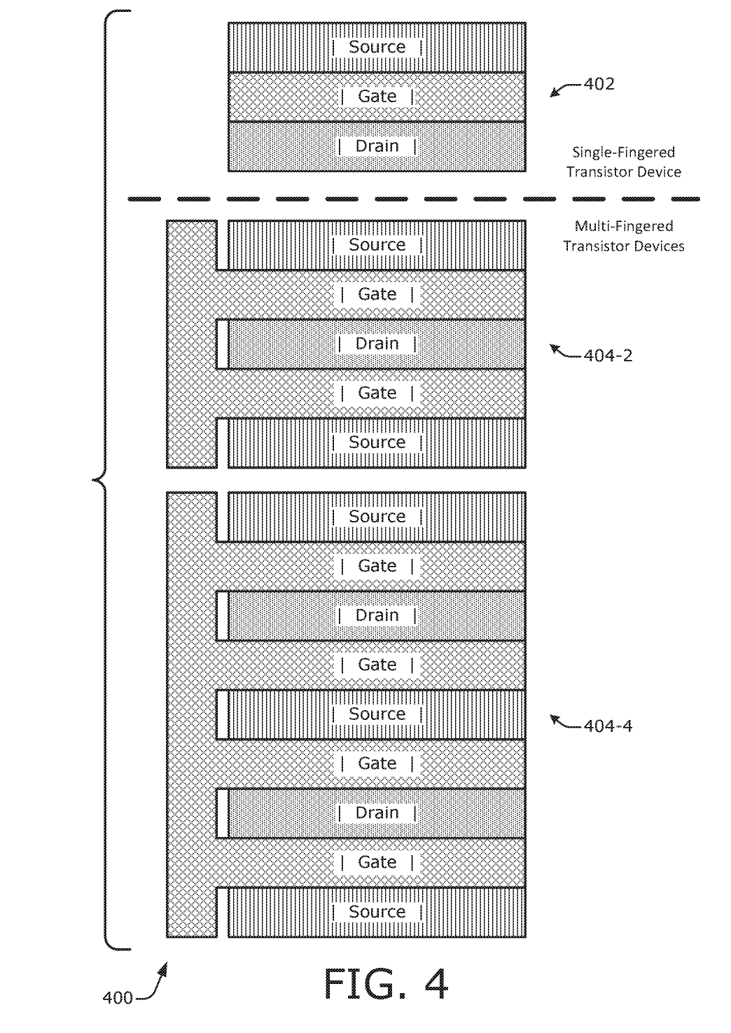

FIG. 4 illustrates generally at 400 examples of transistor devices having different numbers of fingers. An example of a cell attribute for a cell attribute collection 306 is the number of fingers used to implement the corresponding circuit device 304. Any number of fingers can be used. A transistor 402 is an example of a single-fingered transistor device. Two transistors 404 are examples of multi-fingered transistor devices. A transistor 404-2 includes two fingers, and a transistor 404-4 includes four fingers. As shown in FIG. 4, a number of fingers for a transistor device corresponds to a number of drain-source pairs or a number of gates. However, different numbers of fingers may be implemented in alternative manners. For example, a single-fingered circuit device having one transistor of a given size may be implemented as a three-fingered circuit device having three transistors that are each one-third the given size.

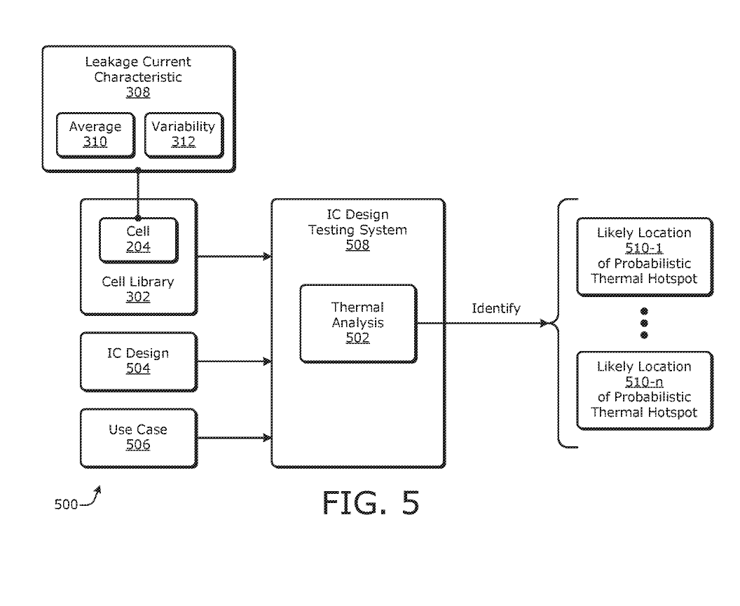

FIG. 5 illustrates an example approach 500 to identifying multiple likely locations 510 of probabilistic thermal hotspots. The approach 500 includes an integrated circuit design testing system 508 that can perform a thermal analysis 502, a cell library 302, an integrated circuit design 504, and at least one use case 506. The cell library 302 includes at least one cell 204 with a corresponding leakage current characteristic 308. The integrated circuit design testing system 508 identifies multiple likely locations 510-1 . . . 510-n of at least one probabilistic thermal hotspot.

The integrated circuit design 504 describes which circuit devices 304 are to be included in the integrated circuit 106 and how the circuit devices 304 are to be interconnected. The integrated circuit design testing system 508 simulates operation of the integrated circuit design 504 in accordance with the use case 506 to test the integrated circuit design 504 for one or more operational conditions. An example of an operational condition is a thermal response of the integrated circuit design 504. Thus, the integrated circuit design testing system 508 performs a thermal analysis 502 on the integrated circuit design 504 for a given use case 506. Examples of use cases 506 are playing a video, downloading data, rendering three-dimensional graphics in a game, simultaneously using multiple radios, processing camera data, and combinations thereof. Each use case 506 corresponds to a set of instructions that are executed to simulate the use case 506.

In an example operative implementation, the integrated circuit design testing system 508 obtains a cell library 302, an integrated circuit design 504, and at least one use case 506. The cell library 302 includes descriptions for at least those cells 204 that are included in the integrated circuit design 504. Each cell 204 includes or corresponds to a cell attribute collection 306 (of FIG. 3) having a leakage current characteristic 308 with a leakage current average 310 and a leakage current variability 312 for the corresponding circuit device 304. The integrated circuit design testing system 508 performs a thermal analysis 502 on the integrated circuit design 504 with reference to the cell library 302. The effects of leakage current variability 312 by each circuit device 304 are stochastically incorporated into the thermal analysis 502 to identify locations at which probabilistic thermal hotspots 102 may be produced as a result of execution of the instructions for a single use case 506. The thermal analysis 502 can be conducted on a region-by-region basis, temperature results can be constrained to pertain to individual ones of different regions 202 of FIG. 2, some combination thereof, and so forth.

Because leakage current is characterized in terms of both a leakage current average 310 and a leakage current variability 312, the thermal analysis 502 identifies multiple probabilistic thermal hotspots, even for a single use case 506. In other words, multiple likely locations 510 are identified at which at least one thermal hotspot has some probability of occurring for the given use case 506. The thermal analysis 502 can reveal which location is more or most likely to produce a thermal hotspot. However, due to the variability of leakage current arising from random variations in the physical structure of the integrated circuit (e.g., due to random dopant fluctuations), no single location can be identified with certainty. Consequently, any of multiple likely locations 510 may generate a probabilistic thermal hotspot during operation of an integrated circuit that is built in accordance with the integrated circuit design 504, even for a single use case 506.

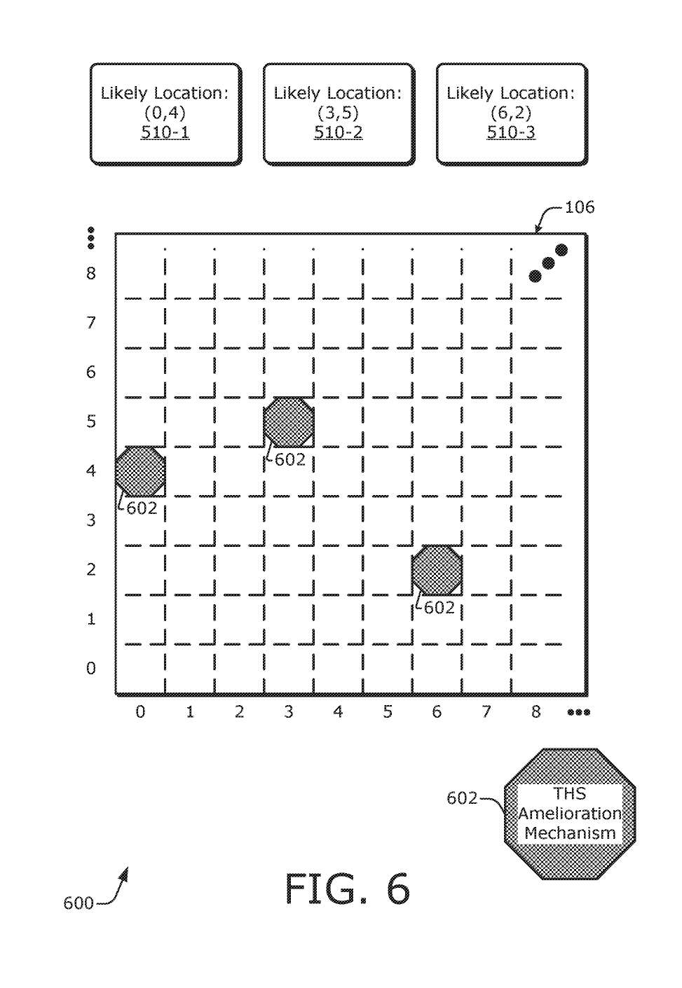

FIG. 6 illustrates an example integrated circuit 106 that includes multiple thermal hotspot amelioration mechanisms 602. With a thermal analysis 502 conducted by an integrated circuit design testing system 508 of FIG. 5, multiple likely locations 510 of at least one probabilistic thermal hotspot are identified. For each likely location 510, a thermal hotspot amelioration mechanism is designated for incorporation into the integrated circuit chip. Likely locations 510 can be indicated in any of a number of different manners. For example, a location 510 can be indicated with reference to a region 202 or a cell 204 of FIG. 2. Alternatively, a location 510 can be indicated with coordinates (e.g., x- and y-coordinates), with linear measurements (e.g., a distance in microns), with an identification that references a particular circuit device or group of circuitry (e.g., an alphanumerical identifier), with an identification of circuitry nodes, some combination thereof, and so forth. An expected size of the probabilistic thermal hotspot may also be indicated as a result of the thermal analysis 502.

As shown, three likely locations 510-1, 510-2, and 510-3 for at least one probabilistic thermal hotspot are identified with example coordinates. The coordinates for the three likely locations 510-1, 510-2, and 510-3 are (0,4), (3,5), and (6,2), respectively. At each designated likely location 510 of the integrated circuit 106, a thermal hotspot amelioration mechanism 602 is incorporated into the integrated circuit 106. The thermal hotspot amelioration mechanism 602 functions to actively or passively dissipate heat generated at the corresponding likely location 510 to lower the resulting temperature or retard development of a thermal hotspot. Consequently, the thermal hotspot amelioration mechanism 602 can at least ameliorate development of a probabilistic thermal hotspot at the likely location 510. Examples of a thermal hotspot amelioration mechanism 602 include a thermal via such as a cooling bump, a thermoelectric cooling (TEC) unit, a heat sink, or a combination thereof.

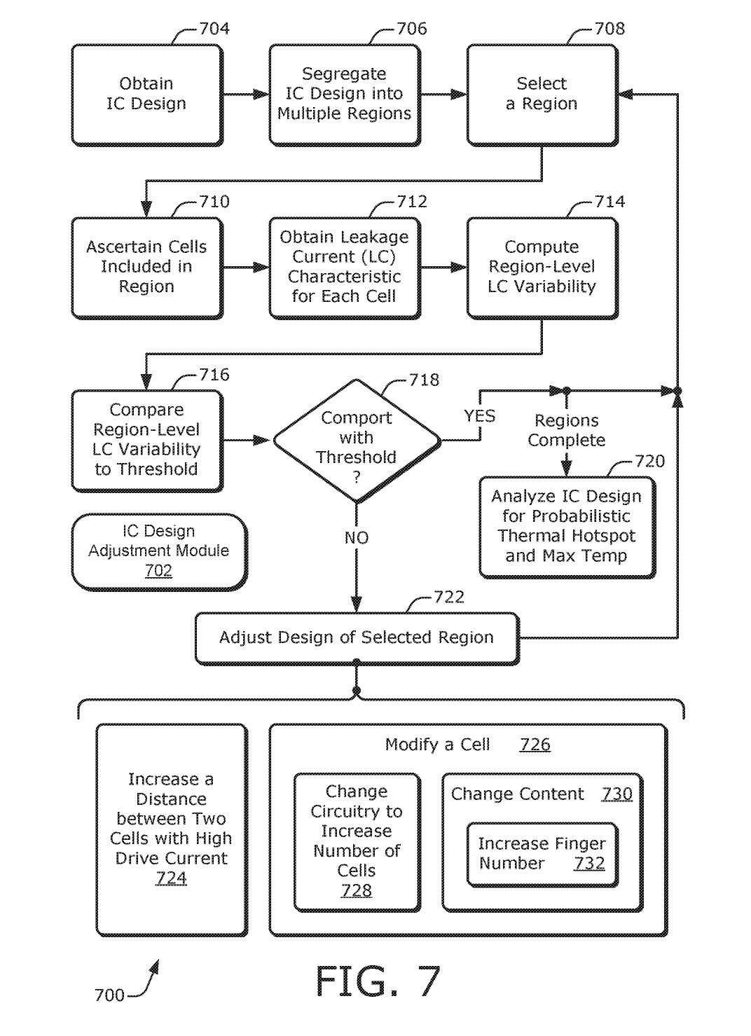

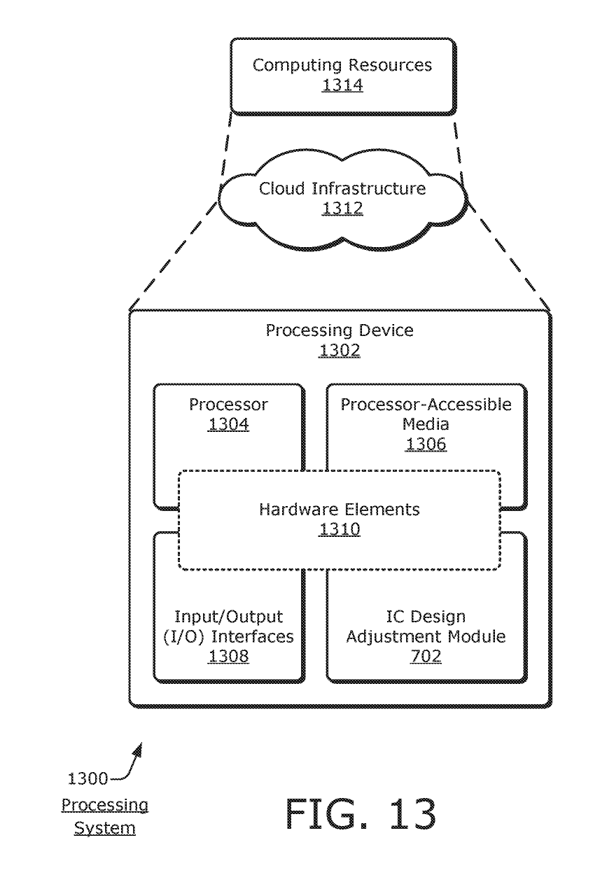

FIG. 7 is a flow chart illustrating an example process 700 for managing tolerance to leakage current variability on a region-by-region basis. The process 700 includes at least some of example operations 704-732. The operations are not necessarily limited to the order shown in FIG. 7 or described herein, for the operations may be implemented in alternative orders or in fully or partially overlapping manners. An integrated circuit design adjustment module 702 performs at least a portion of the process 700. The integrated circuit design adjustment module 702 can be implemented by a processing system, an example of which is described below with reference to FIG. 13. The integrated circuit design adjustment module 702 may be implemented as at least part of a software package that executes on and specially configures one or more processors; as a hardware apparatus; or using a combination of software, hardware, firmware, or fixed logic circuitry; with some combination thereof; and so forth. Examples of hardware and associated logic are described herein, also with reference to FIG. 13.

At an operation 704, an integrated circuit design 504 is obtained. At an operation 706, the integrated circuit design adjustment module 702 segregates the integrated circuit design 504 into multiple regions 202. A region 202 is selected at an operation 708. At an operation 710, by inspecting the circuitry of the selected region 202 as described by the integrated circuit design 504, the integrated circuit design adjustment module 702 ascertains which cells 204 are included in the selected region 202.

The integrated circuit design adjustment module 702 has access to a cell library 302. With reference to the cell library 302, the leakage current characteristic 308 for each cell 204 in the selected region 202 is obtained at an operation 712. The leakage current characteristic 308 includes a leakage current average 310 and a leakage current variability 312. At an operation 714, the integrated circuit design adjustment module 702 computes a region-level leakage current variability using the respective leakage current variabilities 312 of the individual cells 204 that are included in the currently-selected region 202. This effective leakage current variability for the selected region 202 represents how susceptible the region 202 is to producing a probabilistic thermal hotspot due to the local variations that can cause wide swings of leakage current from one circuit device to the next.

At an operation 716, the integrated circuit design adjustment module 702 compares the computed region-level leakage current variability to a region-level leakage current variability threshold. Whether the computed region-level leakage current variability comports with the threshold is determined at an operation 718. For example, the integrated circuit design adjustment module 702 can determine if the value of the computed region-level leakage current variability is less than the value of the threshold. If so, the value of the computed region-level leakage current variability is determined to comport with the threshold and the currently-selected region 202 is not adjusted. Instead, another region is selected for analysis at operation 708. If no additional regions are to be analyzed in terms of region-level leakage current variability, then at an operation 720, the integrated circuit design 504 is analyzed for probabilistic thermal hotspots. The integrated circuit design adjustment module 702 can perform a thermal analysis of the integrated circuit design 504 to identify likely locations for probabilistic thermal hotspots. The integrated circuit design testing system 508 of FIG. 5, for example, can perform such a thermal analysis. Regardless, a maximum expected temperature for the probabilistic thermal hotspots can also be computed. Additionally or alternatively, the integrated circuit design adjustment module 702 can utilize a region-level leakage current variation spread indicator as a threshold for the operation 718.

On the other hand, if the computed region-level leakage current variability does not comport with the threshold as determined at the operation 718, the integrated circuit design adjustment module 702 adjusts a design of the circuitry within the selected region 202 at an operation 722. To adjust the design of the circuitry within the selected region 202, one or more of several approaches to lowering the region-level leakage current variability may be implemented individually or jointly as depicted at operations 724-732. These approaches involve at least multi-cell or intra-cell design adjustments. At an operation 724, a distance between two cells 204 with high drive current is increased. If two cells 204 are associated with drive currents that comport with a drive current factor, the integrated circuit design adjustment module 702 rearranges a location of at least one cell of the selected region 202 to increase the distance between the two cells 204. A drive current factor may include, for example, one drive current threshold, two drive current thresholds that differ from each other, or a distance threshold in conjunction with at least one drive current threshold.

At an operation 726, the integrated circuit design adjustment module 702 modifies at least one cell 204 of the selected region 202. In one approach to cell modification, circuitry is changed to increase a number of cells within the selected region 202 at an operation 728. Generally, first circuitry corresponding to a first number of one or more cells can be changed into second circuitry corresponding to a second number of cells. The first circuitry is to function at least similarly to the second circuitry, and the second number is greater than the first number. For example, one cell that performs a given function can be replaced by two cells that perform the same or similar function while occupying a comparable amount of chip area as does the one cell.

In another approach to cell modification, a content of a cell 204 is changed at an operation 730. For example, one type of circuit device that is less tolerant to local variations can be replaced by another type of circuit device that is more tolerant of local variations. At an operation 732, the integrated circuit design adjustment module 702 increases a number of fingers for a cell 204. For instance, a finger parameter that is included in a cell attribute collection 306 can be increased for a given circuit device 304 by changing the design of the circuit device 304. With reference also to FIG. 4, a single-fingered transistor device 402 is replaced by a multi-fingered transistor device 404 to lower the leakage current variability 312 of the cell 204 being modified. After the operation 722, the process 700 continues with the operation 708. A new region 202 may be selected for analysis, or the current region 202 may be selected again so as to analyze the adjusted design of the current region 202.

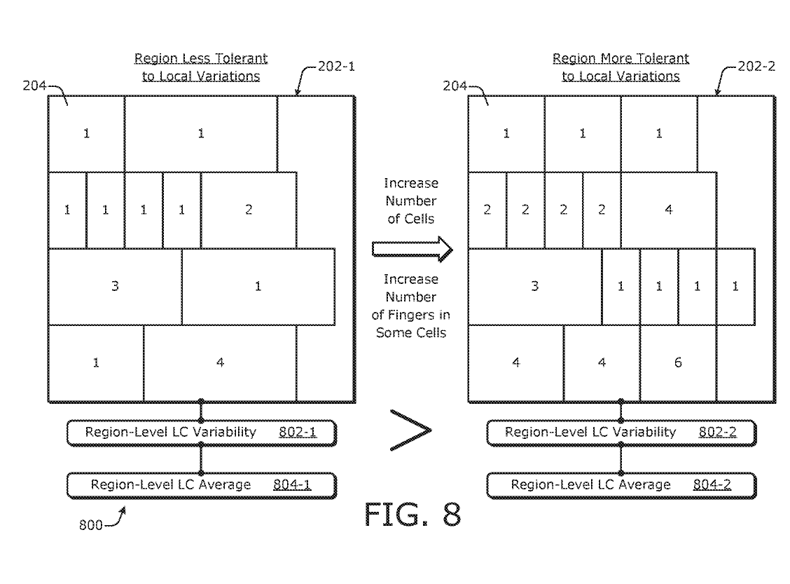

FIG. 8 illustrates generally at 800 a region 202-1 that is relatively less tolerant and a region 202-2 that is relatively more tolerant to local variations that cause leakage current variability. The region 202-1 on the left corresponds to a region-level leakage current variability 802-1 and a region-level leakage current average 804-1. The region 202-2 on the right corresponds to a region-level leakage current variability 802-2 and a region-level leakage current average 804-2. The region-level leakage current variability 802-1 is greater than the region-level leakage current variability 802-2. The region 202-2 represents a state of the region 202-1 after one or more design adjustments have been implemented, such as by the operation 722 of FIG. 7. In the illustrated example, two approaches to lowering the region-level leakage current variability 802 are implemented to transform the design of the region 202-1 into the design of the region 202-2. These two are approaches are increasing the number of cells within the region 202 and increasing the number of fingers in some cells.

As illustrated, each region 202 has four rows and includes multiple cells 204. Only two cells 204 are specifically indicated by reference number for the sake of visual clarity. Each cell has one numeral depicted therein. The depicted numeral represents a finger parameter for the cell. To adjust a design of the region 202, in the top row, the number of cells is increased by replacing the larger single cell with two smaller cells. In the second row, the number of fingers in each cell is increased. Specifically, the number of fingers is doubled from one-to-two or from two-to-four for each cell. In the third row, the right cell is replaced by four smaller cells that perform the same or at least a similar function. In the bottom row, the left cell having one finger is replaced by a same-sized cell having four fingers. Additionally, the right cell having four fingers is replaced by two smaller cells having four or six fingers.

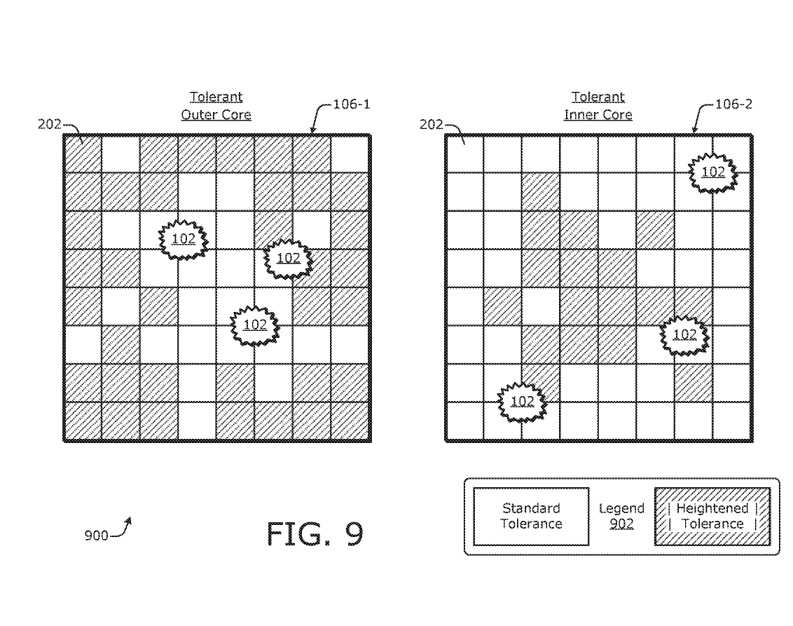

These kinds of design adjustments for the region 202, as well as others described herein, can decrease the region-level leakage current variability 802. Decreasing the region-level leakage current variability 802 causes the region 202 to become more tolerant to local variations. This manages thermal performance because a region that is rendered more tolerant to local variations results in the region being less likely to develop, or less likely to contribute toward the production of, a probabilistic thermal hotspot due to leakage current. Tuning the region-level leakage current variability 802 of selected individual regions 202 enables non-random patterns of tolerance to be created across an integrated circuit, and such non-random tolerance patterns can further enable probabilistic thermal hotspots to be accommodated. Chip-level tolerance patterns are described with reference to FIG. 9.

FIG. 9 illustrates generally at 900 an integrated circuit 106-1 having an outer core with a heightened tolerance to local variations and an integrated circuit 106-2 having an inner core with a heightened tolerance to local variations. Each integrated circuit 106 includes an array of multiple regions 202. Only two regions 202 are specifically indicated by reference number for the sake of visual clarity. For these two illustrated examples of a non-random pattern of relative levels of tolerance, each region 202 is depicted as being either white or shaded. As indicated by a legend 902, white regions have a standard tolerance, and shaded regions have a heightened tolerance to local variations. In other words, white regions include circuitry that is produced using conventional design strategies. In contrast, the shaded regions have undergone one or more design adjustments, such as those implemented by the operation 722 of FIG. 7. Hence, the region-level leakage current variability 802 of the shaded regions is on average lower than the region-level leakage current variability 802 of the white regions. In a more general implementation, some regions may have one level of tolerance while other regions have one of multiple higher levels of tolerances to produce a gradient of tolerances across the integrated circuit 106.

Different non-random patterns of tolerance can be created on an integrated circuit 106 by selectively applying design adjustments to some regions or by selectively applying more aggressive design adjustments to some regions as compared to other regions. As shown in FIG. 9, two areas of the integrated circuit 106 are roughly separated into an outer core and inner core. The areas are defined like a ring or a two-dimensional doughnut. As shown on the left by the integrated circuit 106-1, the outer core corresponds to the doughnut. As shown on the right by the integrated circuit 106-2, the inner core corresponds to the hole defined by such a doughnut.

To produce an integrated circuit 106-1 having a tolerant outer core, at least some of the regions 202 along the outer core are adjusted to decrease respective region-level leakage current variabilities 802 to the extent practicable given the constituent cells and surrounding circuitry of any given region 202 in the outer core. This has the effect of increasing the likelihood that a location of a probabilistic thermal hotspot 102 develops in the vicinity of the inner core. To produce an integrated circuit 106-2 having a tolerant inner core, at least some of the regions in the inner core are adjusted to decrease respective region-level leakage current variabilities 802 to the extent practicable given the constituent cells and surrounding circuitry of any given region 202 in the inner core. This has the effect of increasing the likelihood that a location of a probabilistic thermal hotspot 102 develops in the vicinity of the outer core.

Creating a chip-level, non-random pattern of relative levels of tolerance enables the shifting of one or more likely locations for the development of a probabilistic thermal hotspot to one or more targeted areas. An area can be targeted if the area is already designated to be covered by a heat-dissipation mechanism of some kind, if the area is expected to generate less heat from drive currents than another area, if heat is expected to naturally dissipate from the area more easily than another area, for some combination of such reasons, and so forth. With an inner/outer core pattern, for example, heat can naturally dissipate more easily or quickly from an edge of an integrated circuit 106 than from areas that are surrounded by other operational circuitry. In some simulations, an inner-core-tolerant integrated circuit 106-2 produced a hotspot temperature that was approximately 10 Celsius degrees cooler than a hotspot temperature produced by a standard design technique with no adjusted regions. With respect to an outer-core-tolerant integrated circuit 106-1, the inner-core-tolerant integrated circuit 106-2 produced a hotspot temperature that was approximately 15 Celsius degrees cooler.

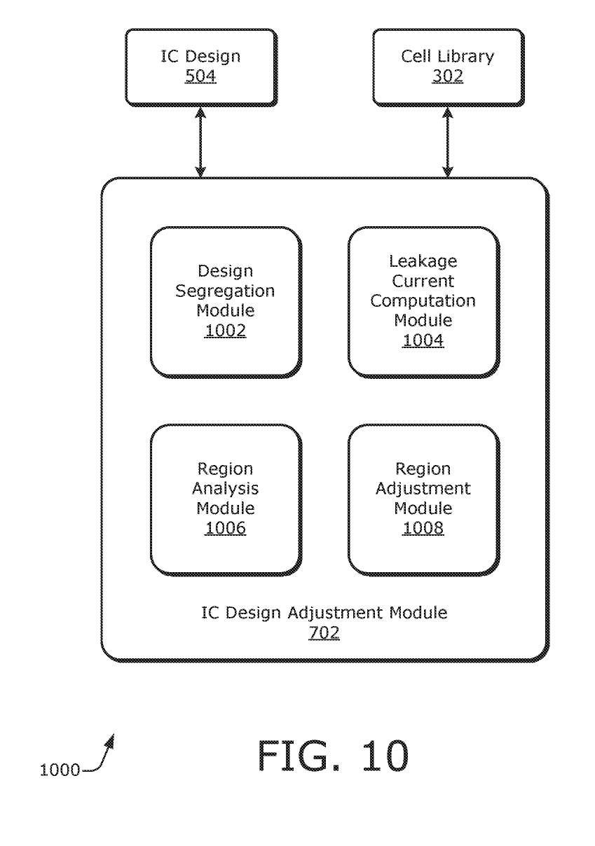

FIG. 10 illustrates generally at 1000 an example of an integrated circuit design adjustment module 702 to manage tolerance for leakage current variability on a region-by-region basis. As described with reference to FIG. 7, the integrated circuit design adjustment module 702 operates on an integrated circuit design 504 using a cell library 302 to produce an adjusted design 504 having one or more regions 202 that have been individually or separately adjusted. As illustrated in FIG. 10, the integrated circuit design adjustment module 702 includes a design segregation module 1002, a leakage current computation module 1004, a region analysis module 1006, and a region adjustment module 1008. In example implementations, the integrated circuit design adjustment module 702 obtains the integrated circuit design 504 and adjusts the integrated circuit design 504 to manage the likely development of probabilistic hotspots by lowering the region-level leakage current variability 802 of some regions 202 of the design.

The design segregation module 1002 segregates the integrated circuit design 504 into multiple regions 202. The segregation can use multiple rectangular grids to create an array of rectangular grids to logically separate different circuitry portions for separate leakage current analysis, such as by performing the operation 706 of FIG. 7. The design segregation module 1002 provides segregation means for segregating an integrated circuit design into multiple regions.

The leakage current computation module 1004 computes a region-level leakage current variability 802 corresponding to each respective region 202 of the multiple regions 202. The leakage current variability is indicative of a probable spread of an average leakage current within each respective region 202. The leakage current computation module 1004 uses the cell library 302 to obtain leakage current characteristics 308 of each circuit device 304 included in a given region 202 to thereby enable performance of the operations 710-714 of FIG. 7. The leakage current computation module 1004 provides computation means for computing a leakage current variability corresponding to each respective region 202 of the multiple regions, with the leakage current variability indicative of a likely spread of a leakage current within each respective region 202. Each of the leakage current characteristics 308 includes a leakage current variability 312 corresponding to an individual cell 204 of the respective region 202. The leakage current variabilities 312 are used to determine the region-level leakage current variability 802 for the respective region 202. In such implementations, the leakage current computation module 1004 provides calculation means for calculating a region-level leakage current variability 802 for a particular region 202 of the multiple regions using respective leakage current variabilities 312 corresponding to respective cells 204 included in the particular region 202.

The region analysis module 1006 analyzes the multiple regions 202 based on the computed leakage current variability corresponding to each respective region 202 of the multiple regions 202. For example, the region-level leakage current variability 802 of a respective region 202 is compared to a value for a region-level leakage current variability threshold, or a region-level leakage current variation spread indicator of a respective region 202 is compared to a value for a region-level leakage current variation spread indicator threshold. Such comparisons and analysis correspond to the operations 716-718 of FIG. 7. The region analysis module 1006 provides analysis means for analyzing the multiple regions based on the leakage current variability corresponding to each respective region 202 of the multiple regions. In an example operative implementation, whether a design of a particular region 202 is to be adjusted depends on a comparison including the region-level leakage current variability 802 and a threshold value for an effective leakage current variability of each region. In such implementations, the region analysis module 1006 provides determination means for determining if a particular region 202 is to be adjusted based on the leakage current variability corresponding to the particular region 202 and a leakage current variability threshold.

The region adjustment module 1008 adjusts a design of one or more regions 202 of the multiple regions 202 based on an analysis, which is performed by the region analysis module 1006, to manage likely development of at least one probabilistic thermal hotspot 102 due to the leakage current flows within the region 202. The design of the circuitry of a region 202 can be adjusted at an inter-cell level by moving a cell 204 or at an intra-cell level by modifying a cell 204, such as by performing the operation 722 (e.g., any of operations 724-732) of FIG. 7. The region adjustment module 1008 provides adjustment means for adjusting a design of at least one region 202 of the multiple regions based on the analysis to manage likely development of at least one probabilistic thermal hotspot 102 due to the leakage current.

The design architecture of a region 202 can be adjusted to decrease a region-level leakage current variability 802 thereof by increasing a distance between two cells 204 having high drive current in the region 202, by changing circuitry corresponding to a cell 204 to increase a number of cells 204 in the region 202, by increasing a number of fingers used to implement a circuit device 304, some combination thereof, and so forth. By decreasing the region-level leakage current variability 802, the tolerance of the region 202 increases for handling local variations with respect to thermal performance of the integrated circuit. In such implementations, the region adjustment module 1008 provides tolerance means for increasing a tolerance of the at least one region 202 to local variations with respect to thermal performance by decreasing a region-level leakage current variability 802 of the at least one region 202.

As described above with reference to FIG. 9, a leakage-current-variability tolerance pattern can be created by selecting certain regions 202 for potential design adjustment or more aggressive design adjustment in accordance with the operation 722. By adjusting a design for at least some regions 202 to decrease respective region-level leakage current variabilities 802 of the regions 202 in one area, likely locations 510 for development of at least one probabilistic thermal hotspot 102 can be shifted to another area. The relationship between or among different areas that have been tuned to have differing levels of leakage current variability establishes one or more tolerance patterns with regard to local variations of the integrated circuit chip. In such implementations, the region adjustment module 1008 provides pattern creation means for creating a tolerance pattern by shifting one or more likely locations 510 for development of at least one probabilistic thermal hotspot 102.

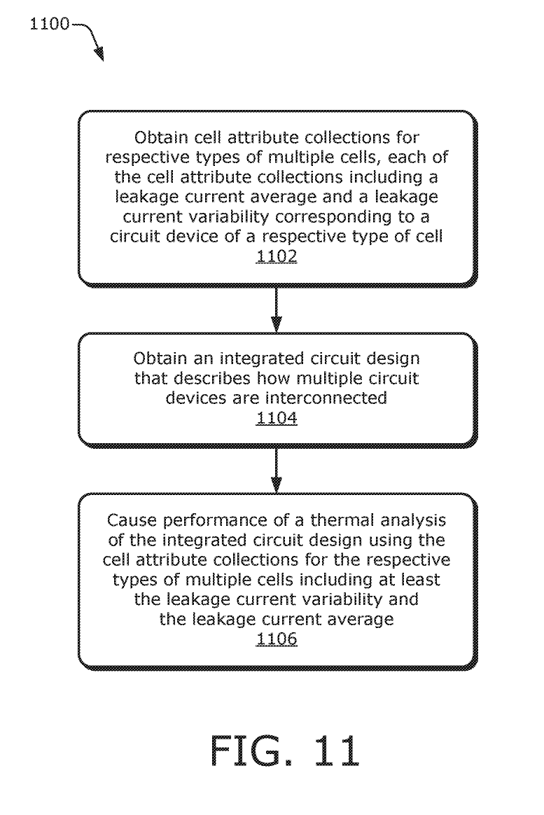

FIG. 11 is a flow diagram illustrating an example process 1100 for probabilistic thermal hotspot accommodation. Process 1100 is described in the form of a set of blocks 1102-1106 that specify operations that may be performed. However, operations are not necessarily limited to the order shown in FIG. 11 or described herein, for the operations may be implemented in alternative orders or in fully or partially overlapping manners. Operations represented by the illustrated blocks of process 1100 may be performed by a system, such as a processing system 1300 of FIG. 13, which system includes a processing device 1302.

At block 1102, cell attribute collections are obtained for respective types of multiple cells, with each of the cell attribute collections including a leakage current average and a leakage current variability corresponding to a circuit device of a respective type of cell. For example, a processing device 1302 can obtain cell attribute collections 306 for respective types of multiple cells 204, with each of the cell attribute collections 306 including a leakage current average 310 and a leakage current variability 312 corresponding to a circuit device 304 of a respective type of cell 204. For instance, an integrated circuit design testing system 508 may obtain cell attribute collections 306 by retrieving a cell library 302 from memory, by receiving a cell library 302 from another device or entity, some combination thereof, and so forth.

At block 1104, an integrated circuit design that describes how multiple circuit devices are interconnected is obtained. For example, the processing device 1302 can obtain an integrated circuit design 504 that describes how multiple circuit devices 304 are interconnected. The integrated circuit design testing system 508 may, for instance, obtain a circuit layout from memory or from another device or entity to determine how the circuit devices 304 are coupled to one another.

At block 1106, a performance of a thermal analysis is caused to occur for the integrated circuit design using the cell attribute collections for the respective types of multiple cells including at least the leakage current variability and the leakage current average. For example, the processing device 1302 can cause a performance of a thermal analysis 502 of the integrated circuit design 504 using the cell attribute collections 306 for the respective types of multiple cells 204 including at least the leakage current variability 312 and the leakage current average 310. To do so, the integrated circuit design testing system 508 can simulate operation of the integrated circuit design 504 in accordance with at least one use case 506 to analyze a thermal performance of the design responsive to expected leakage current flows with regard to the leakage current variability 312 as well as the leakage current average 310. The thermal analysis 502 may reveal multiple likely locations 510 of at least one probabilistic thermal hotspot 102.

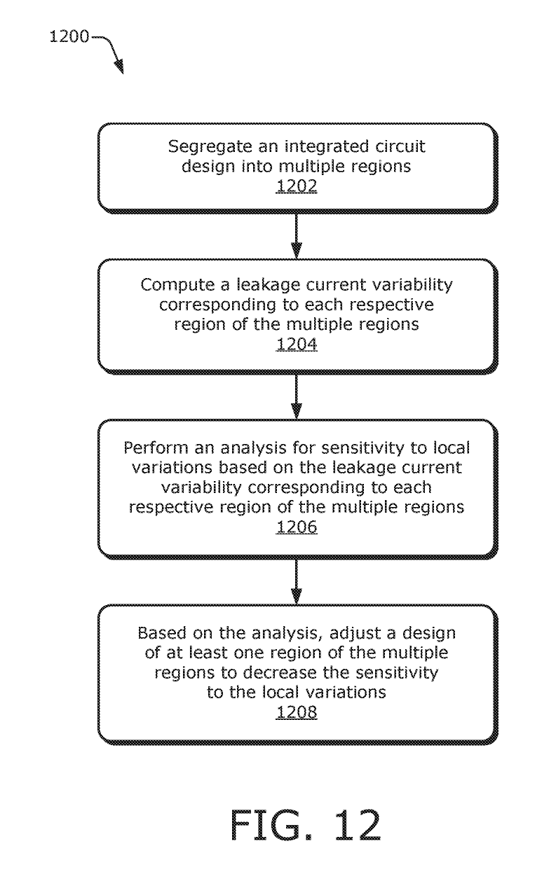

FIG. 12 is a flow diagram illustrating an example process 1200 for probabilistic thermal hotspot accommodation. Process 1200 is described in the form of a set of blocks 1202-1208 that specify operations that may be performed. However, operations are not necessarily limited to the order shown in FIG. 12 or described herein, for the operations may be implemented in alternative orders or in fully or partially overlapping manners. Operations represented by the illustrated blocks of process 1200 may be performed by an integrated circuit design adjustment module 702 of FIG. 7 or by a system, such as a processing system 1300 of FIG. 13, which system includes a processing device 1302.

At block 1202, an integrated circuit design is segregated into multiple regions. For example, a processing device 1302 can segregate an integrated circuit design 504 into multiple regions 202. For instance, a design segregation module 1002 may logically separate the circuitry of the integrated circuit design 504 into regions 202, such as rectangular grids, to enable localized or small-scale consideration of the thermal effects of leakage currents from multiple circuit devices 304.

At block 1204, a leakage current variability corresponding to each respective region of the multiple regions is computed. For example, the processing device 1302 can compute a region-level leakage current variability 802 corresponding to each respective region 202 of the multiple regions 202. To do so, a leakage current computation module 1004 may stochastically combine the multiple leakage current variabilities 312 respectively corresponding to the multiple circuit devices 304 of each region 202 into a corresponding region-level leakage current variability 802 for each region 202.

At block 1206, an analysis for sensitivity to local variations is performed based on the leakage current variability corresponding to each respective region of the multiple regions. For example, the processing device 1302 can perform an analysis for sensitivity to local variations based on the region-level leakage current variability 802 corresponding to each respective region 202 of the multiple regions 202. To perform the analysis, a region analysis module 1006 may compare the region-level leakage current variability 802 to a region-level leakage current variability threshold, may compare a computed region-level leakage current variation spread indicator to a region-level leakage current variation spread indicator threshold, some combination thereof, and so forth. The region-level leakage current variability 802 or the region-level leakage current variation spread indicator is indicative of the sensitivity of each region 202 to random local variations in the physical structure of an integrated circuit 106.

At block 1208, based on the analysis, a design of at least one region of the multiple regions is adjusted to decrease the sensitivity to the local variations. For example, based on the analysis that uses the leakage current variability, the processing device 1302 can adjust a design of the circuitry of at least one region 202 of the multiple regions 202 at the inter-cell or intra-cell level to decrease the sensitivity of the at least one region 202 to the local variations. The design adjustment of the region 202 may be made by a region adjustment module 1008 to decrease the sensitivity to local variations by decreasing the region-level leakage current variability 802. For instance, the region adjustment module 1008 may modify a cell 204 of the region 202 by increasing a number of cells employed to perform the same or similar functionality of the cell 204 or by changing the content of the cell 204, such as by increasing a finger parameter corresponding to the cell 204. By decreasing a region's sensitivity to the random local variations, the region's tolerance for these local variations is increased and the probability of producing a thermal hotspot due to leakage current is reduced.

FIG. 13 depicts an example of a processing system 1300 to implement a process or system in accordance with one or more example implementations. For example, the integrated circuit design adjustment module 702 can be realized using the processing system 1300 as shown. Additionally or alternatively, the processing system 1300 can be used to implement the approach 500 of FIG. 5, the process 1100 of FIG. 11, the process 1200 of FIG. 12, and so forth. As shown, the processing system 1300 includes at least one processing device 1302, which may be implemented as part of or with support from a cloud infrastructure 1312 that provides one or more computing resources 1314.

The example processing device 1302 as illustrated includes at least one processor 1304, one or more processor-accessible media 1306, and one or more input/output (I/O) interfaces 1308. Components realizing these functionalities are communicatively coupled to each other using a system bus or other data and command transfer fabric. A data and command transfer fabric can be local to a single physical machine or distributed geographically or among many different machines. The processor 1304, the processor-accessible media 1306, the I/O interfaces 1308, and the integrated circuit design adjustment module 702 are representative of components that can provide processing, storage, communication, or analytical functionality or associated operations using hardware. Accordingly, each is illustrated as including one or more hardware elements 1310.

The processor 1304 can be implemented using one or more processing units that work individually or jointly in a localized or distributed fashion to execute instructions. Examples of processors 1304 include a general-purpose processor, an application specific integrated circuit (ASIC), a microprocessor, a digital signal processor (DSP), hard-coded discrete logic, distributed processing resources, or a combination thereof. The processor-accessible media 1306 can include memory or distributed storage resources to retain processor-executable instructions for software, modules, firmware, and so forth. Memory may be volatile or nonvolatile memory and may be fixed or removable. Examples of memory include random access memory (RAM), read only memory (ROM), flash memory, optical discs, magnetic disks, magnetoresistive RAM (MRAM), resistive RAM (RRAM), or a combination thereof.

The I/O interfaces 1308 may include person-machine interfaces or inter-machine interfaces. Examples of person-machine input interfaces include a microphone, a keyboard, a mouse, a touch-sensitive pad or screen, an accelerometer, a scanner, a camera, or a combination thereof. Examples of person-machine output interfaces include a speaker, a display screen or projector, a haptic device, a printer, or a combination thereof. Examples of inter-machine interfaces include a wireless adapter, a wired adapter, a network card, a port, a switching fabric, or a combination thereof.

Implementations that are described herein may be realized using the hardware elements 1310, software, firmware, modules, a combination thereof, and so forth. Modules, for example, may include at least software or firmware that is rendered tangible via execution by the processor 1304 or storage by the processor-accessible media 1306. Generally, modules may include routines, programs, objects, components, data structures, instructions, combinations thereof, and so forth that perform particular operations upon execution. Modules may be stored on the processor-accessible media 1306.

The processor-accessible media 1306 can include computer-readable storage media. “Computer-readable storage media,” as used herein, includes media or devices that enable persistent or non-transitory storage of information, which is in contrast to mere signal transmission, carrier waves, or signals per se. Computer-readable storage media does not include signals per se or signal-bearing media. In one example, processor 1304 accesses computer-executable code from the computer-readable storage media 1306 and executes that code to provide the functionality discussed above with respect to the various flowcharts.

The implementations described herein may be enabled or supported by various configurations of the processing device 1302 and are not limited to the specific aspects of the example devices described herein. The processing functionality may also be fully or partially implemented through use of a distributed processing system, such as one realized using cloud infrastructure 1312. Thus, the processing device 1302 can rely on the cloud infrastructure 1312 for computing resources 1314, or the processing device 1302 can be an integral part of the cloud infrastructure 1312.

Cloud infrastructure 1312 may be implemented using multiple server devices, using computing functionality offered by at least one data center, some combination thereof, and so forth. The cloud infrastructure 1312 provides one or more computing resources 1314 by abstracting underlying functionality of hardware (e.g., of one or more servers or a data center) and software computing resources 1314 of the cloud infrastructure 1312. The computing resources 1314 may include applications, data, storage bandwidth, processing cycles, and so forth that can be utilized remotely or using a distributed platform. The computing resources 1314 can also be scalable according to demand.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Further, items represented in the accompanying figures and terms discussed herein may be indicative of one or more items or terms, and thus reference may be made interchangeably to single or plural forms of the items and terms in this written description. Although subject matter has been described in language specific to structural features or methodological operations, it is to be understood that the subject matter defined in the appended claims is not necessarily limited to the specific features or operations described above, including not necessarily being limited to the organizations in which features are arranged or the orders in which operations are performed.

What is claimed is:

1. A method for probabilistic thermal hotspot accommodation, the method comprising:
obtaining cell attribute collections for respective types of multiple cells, each of the cell attribute collections including a leakage current average and a leakage current variability corresponding to a circuit device of a respective type of cell;
obtaining an integrated circuit design that describes how multiple circuit devices are interconnected; and
causing performance of a thermal analysis of the integrated circuit design using the cell attribute collections for the respective types of multiple cells including the leakage current variability and the leakage current average.

2. The method of claim 1, wherein:
the leakage current average comprises at least one value indicative of a mean of the leakage current for the circuit device of the respective type of cell; and
the leakage current variability comprises at least one value indicative of a standard deviation or a variance of the leakage current for the circuit device of the respective type of cell.

3. The method of claim 1, wherein the leakage current variability is stochastically representative of how tolerant the circuit device of the respective type of cell is to local variations in a physical structure of an integrated circuit chip.

4. The method of claim 1, wherein the causing comprises identifying multiple likely locations for at least one probabilistic thermal hotspot.

5. The method of claim 4, wherein the causing comprises identifying the multiple likely locations for the at least one probabilistic thermal hotspot based on a single use case.

6. The method of claim 4, further comprising:
designating a thermal hotspot amelioration mechanism for each likely location of the multiple likely locations for the at least one probabilistic thermal hotspot.

7. The method of claim 1, wherein the causing comprises:
segmenting the integrated circuit design into multiple regions; and
analyzing the integrated circuit design to identify probabilistic thermal hotspots on a region-by-region basis.

8. An integrated circuit comprising:
circuitry configured to execute instructions such that current flowing during execution of the instructions produces a thermal hotspot at one or more of multiple locations of the circuitry; and
multiple hotspot amelioration mechanisms respectively positioned at the multiple locations, the multiple hotspot amelioration mechanisms configured to dissipate heat generated by the thermal hotspot during execution of the instructions.

9. The integrated circuit of claim 8, wherein the multiple hotspot amelioration mechanisms, which are respectively positioned at the multiple locations of the circuitry, are configured to ameliorate different probabilistic thermal hotspots that may be produced as a result of execution of the instructions for a single use case.

10. The integrated circuit of claim 8, wherein the multiple hotspot amelioration mechanisms comprise at least one of a thermal via or a thermoelectric cooling (TEC) unit.

11. The integrated circuit of claim 8, wherein the current flowing during execution of the instructions comprises leakage current.

12. The integrated circuit of claim 8, wherein the multiple locations correspond to likely locations of probabilistic thermal hotspots identifiable from a thermal analysis performed using a leakage current characteristic corresponding to each cell of the circuitry, the leakage current characteristic including a leakage current average and a leakage current variability for a circuit device of the corresponding cell.

13. The integrated circuit of claim 8, wherein the circuitry comprises a non-random pattern of relative levels of tolerance to current leakage variations with respect to thermal performance of the integrated circuit.

14. The integrated circuit of claim 13, wherein the non-random pattern comprises an inner core of the integrated circuit having a heightened tolerance relative to an outer core of the integrated circuit.

15. A method for probabilistic thermal hotspot accommodation, the method comprising:
segregating an integrated circuit design into multiple regions;
computing a leakage current variability corresponding to each respective region of the multiple regions;
performing an analysis for sensitivity to local variations based on the leakage current variability corresponding to each respective region of the multiple regions; and
adjusting, based on the analysis, a design of at least one region of the multiple regions to decrease the sensitivity to the local variations.

16. The method of claim 15, wherein:
each region of the multiple regions comprises a rectangular grid of multiple rectangular grids; and
the segregating comprises segregating the integrated circuit design into the multiple rectangular grids forming an array of rectangular grids.

17. The method of claim 15, wherein:
the leakage current variability corresponding to each respective region comprises a region-level leakage current variability of each respective region; and
the computing comprises computing the region-level leakage current variability of each respective region based on leakage current variabilities that respectively correspond to individual cells included in each respective region.

18. The method of claim 15, wherein the performing comprises:
determining a region-level leakage current variation spread indicator of each respective region based on a region-level leakage current average and a region-level leakage current variability of each respective region; and
analyzing the leakage current variability corresponding to each respective region of the multiple regions based on the region-level leakage current variation spread indicator, the region-level leakage current variation spread indicator indicative of the sensitivity to the local variations.

19. The method of claim 15, wherein the performing comprises performing a comparison using the leakage current variability corresponding to each respective region and a leakage current variability threshold, the leakage current variability indicative of the sensitivity to the local variations for each respective region.

20. The method of claim 15, wherein the adjusting comprises adjusting the design of the at least one region to lower the leakage current variability corresponding to the at least one region to manage a likely location of a probabilistic thermal hotspot.

21. The method of claim 15, wherein the adjusting comprises increasing a distance between two cells of the at least one region, the two cells associated with drive currents that comport with a drive current factor.

22. The method of claim 15, wherein the adjusting comprises modifying a cell of the at least one region.

23. The method of claim 22, wherein the modifying comprises changing first circuitry corresponding to a first number of one or more cells into second circuitry corresponding to a second number of cells, the second number greater than the first number.

24. The method of claim 22, wherein the modifying comprises changing a content of the cell of the at least one region.

25. The method of claim 24, wherein the changing comprises increasing a number of fingers of a circuit device of the cell of the at least one region.

26. A computer program product having a computer readable medium tangibly recording computer program logic for probabilistic thermal hotspot accommodation, the computer program product comprising:
code to segregate an integrated circuit design into multiple regions;
code to compute a leakage current variability corresponding to each respective region of the multiple regions, the leakage current variability indicative of a likely spread of a leakage current within each respective region;
code to analyze the multiple regions based on the leakage current variability corresponding to each respective region of the multiple regions; and
code to adjust a design of at least one region of the multiple regions based on the analyzing to manage likely development of at least one probabilistic thermal hotspot due to the leakage current.

27. The computer program product of claim 26, wherein the code to compute comprises code to calculate a region-level leakage current variability for a particular region of the multiple regions using respective leakage current variabilities corresponding to respective cells included in the particular region.

28. The computer program product of claim 26, wherein the code to analyze comprises code to determine if a particular region is to be adjusted based on the leakage current variability corresponding to the particular region and a leakage current variability threshold.

29. The computer program product of claim 26, wherein the code to adjust comprises code to create a tolerance pattern by shifting one or more likely locations for development of the at least one probabilistic thermal hotspot.

30. The computer program product of claim 26, wherein the code to adjust comprises code to increase a tolerance of the at least one region to local variations with respect to thermal performance by decreasing a region-level leakage current variability of the at least one region.
